(19) United States
(12) Patent Application Publication
(10) Pub. No.: US 2006/0149677 A1
(43) Pub. Date: Jul. 6, 2006

(54) Contextual ad processing on local machine

(75) Inventors: Omar H. Shahine, San Francisco, CA (US); Richard F. Rashid, Redmond, WA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/030,222

(22) Filed: Jan. 6, 2005

(51) Int. Cl. H04L 9/00

(52) U.S. Cl. 705/50

(57) ABSTRACT

A system is disclosed for serving advertisements to a user of a client device. A set of advertisements are downloaded to the client device. Based on data stored on the client device, or action taken on the client device, a subset of the advertisement are chosen for presentation to the user of the client device. In one embodiment, the choice of advertisement to present to the user is based on the content of one or more email messages. The scanning of the email message and the decision as to which advertisement(s) to present are made on the client machine in order to protect the privacy of the user. The chosen advertisements are then displayed with the one or more emails.

### BACKGROUND OF THE INVENTION

1. Field of the Invention

The present invention relates to technology for processing advertisements on a local machine.

2. Description of the Related Art

The use of e-mail has expanded. More and more people are using e-mail for business and personal reasons. One particular form of e-mail that has become more popular is web-based e-mail services. Rather than using a dedicated e-mail client, web-based e-mail services allow a user to access an e-mail inbox using an Internet browser. This allows a user to access e-mail from any computer, without requiring the computer to have an e-mail application installed. Thus, users traveling can access e-mail from any place there is a computer connected to the Internet.

Web-based e-mail is not the only web-based service that is popular. There are a tremendous amount of Internet-based services available to people throughout the world. Many of these services are for-profit services. There are various business models for making money on the Internet with Internet-based services. One business model uses advertisements to generate revenue to support the service. For example, many users of the Internet will utilize search engines to find content of interest. Users are typically not charged for use of the search engine. Rather, to pay for the search engine, many search engines will sell advertisements. In one example, a search engine will use key words typed in for a particular search to identify relevant advertisements. When the search results are displayed to the user, the search engine will also display a set of advertisements deemed most appropriate for the search words typed in by the user.

Some web-based e-mail services will also use advertisements to generate revenue for the e-mail service. In some embodiments, advertisements will be placed in the graphical user interface (GUI) of the e-mail service. In the past, the advertisements were randomly chosen, or chosen for reasons other than the content of the e-mail. Recently, at least one e-mail service has been scanning content of the e-mail at the email server in an attempt to identify advertisements relevant to the content of the e-mail. The e-mail messages are stored on an e-mail server. That e-mail server is used to store messages for many users. While the e-mail is at the server, the content of the e-mail will be scanned by the server. The content of the e-mail will then be matched to one or more advertisements. The matching of advertisements is performed at the server. The e-mail messages and the one or more relevant advertisements are subsequently sent to the client browser. While this example provides a means for web-based e-mail services to generate revenue to pay for the e-mail service, the scanning of the content of the e-mail could jeopardize the user's privacy.

### SUMMARY OF THE INVENTION

A system is disclosed for serving advertisements to a user of a client device that maintains the privacy of the user. A set of advertisements are downloaded to the client device. Based on data stored on the client device, or actions taken on the client device, a subset of the advertisement are chosen for presentation to the user of the client device. In one embodiment, the choice of advertisement to present to the user is based on the content of one or more email messages. The scanning of the one or more email messages and the decision as to which advertisement(s) to present are made on the client machine in order to protect the privacy of the user. The chosen advertisements are then displayed with the one or more emails. In some embodiments, the advertisements can be displayed separately from the email messages.

One embodiment includes accessing content of a first message at a client device. The first message is received from an email server. One or more advertisements, from a larger set of advertisements that were downloaded to the client device, that are relevant to the content of the first message are identified on the client device. The identified one or more advertisements are provided at an output of the client device. The process remains private because the email server is only aware of the general set of advertisements that were downloaded, but does not know which advertisement was displayed to the user.

The present invention can be accomplished using hardware, software, or a combination of both hardware and software. The software used for the present invention is stored on one or more processor readable storage devices including hard disk drives, CD-ROMs, DVDs, optical disks, floppy disks, tape drives, RAM, ROM, flash memory or other suitable storage devices. In alternative embodiments, some or all of the software can be replaced by dedicated hardware including custom integrated circuits, gate arrays, FPGAs, PLDs, and special purpose processors. In one embodiment, software implementing the present invention is used to program one or more processors. The one or more processors can be in communication with one or more storage devices, peripherals and/or communication interfaces.

### BRIEF DESCRIPTION OF THE DRAWINGS

FIG. 1 is a block diagram of one example of a web based e-mail system.

FIG. 2 is a block diagram of one example of a computing system.

FIG. 3 is a flow chart describing one embodiment of a process performed when interacting with an e-mail system.

FIG. 4 depicts a user interface for one embodiment of an e-mail system.

FIG. 5 is a flow chart describing one embodiment of a process performed when viewing a message.

FIG. 6 is a flow chart describing one embodiment of a process performed when a user selects an advertisement.

FIG. 7 depicts a user interface for one embodiment of an e-mail system.

FIGS. 8-10 depict flow charts describing various embodiments for identifying relevant advertisements.

FIGS. 11-12 depict flow charts describing various embodiments for sending messages.

### DETAILED DESCRIPTION

A system is disclosed that serves advertisements to a user. To protect the privacy of the user, the scanning of content and the decision as to which advertisement to serve to the user are made on the user's client device, rather than on an server used by many different users.

One embodiment includes an e-mail system. One example of an e-mail system is a web-based e-mail service. However, the present invention can apply to other e-mail systems that are not web based. For example, the technology can be applied to an e-mail service based on an e-mail server and a local LAN or other network (e.g., using a Microsoft Exchange Server or other e-mail server). The invention is not limited to any specific e-mail server or service.

The system will download a set of advertisements (“ads”) to a user's machine. These ads may be selected based on an auction process or based on demographics. When the user reads an e-mail message or accesses the inbox (which includes a list of e-mail messages), targeting software on the user's machine will analyze all or a portion of the content of the messages and select one of the locally stored advertisements based on the message content. That process remains completely private because the server is only aware of the general set of ads that were downloaded, but does not know which ad was displayed.

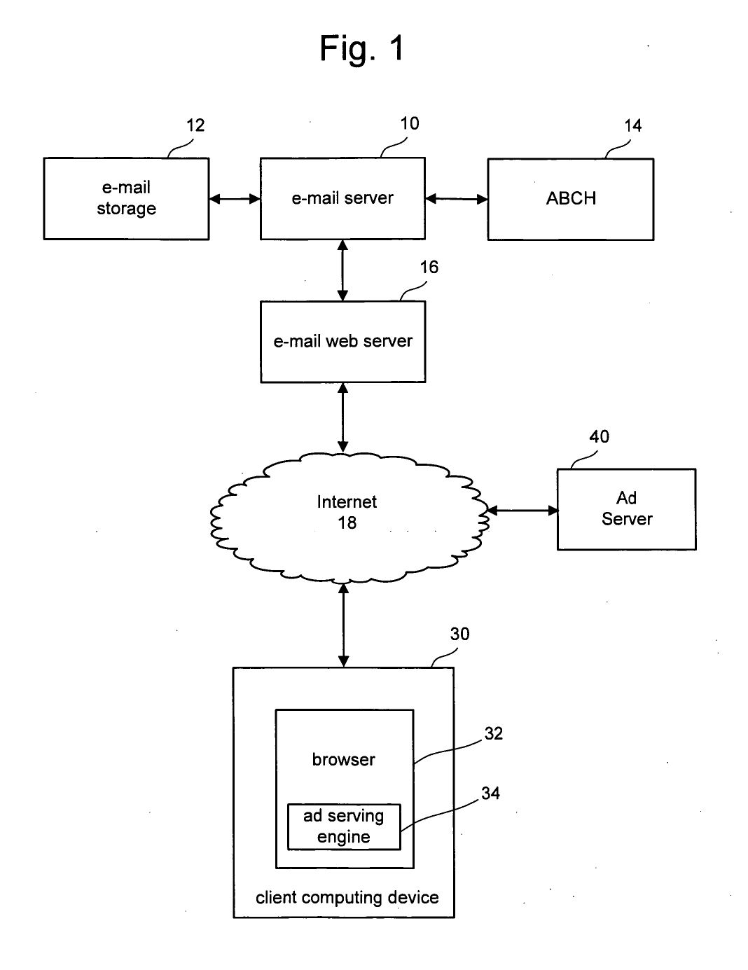

FIG. 1 provides a block diagram of one embodiment of a suitable web-based e-mail system that interacts with a web browser to provide an e-mail service. The system includes an e-mail server 10 that is in communication with e-mail storage system 12, address book clearing house (ABCH) 14, and e-mail web server 16. E-mail web server 16 is in communication, via Internet 18, with one or more client devices 30. FIG. 1 shows client device 30 running browser application 32. Running within or in conjunction with browser application 32 is ad serving engine 34, which is used to choose ads to serve to a user. In one embodiment, ad serving engine 34 is implemented using JavaScript.

E-mail server 10 provides the basic functionality of the web-based e-mail system, and will provide e-mail data to web server 16, and send data to and receive data from ABCH 14. ABCH 14 stores user information. User information can include telephone numbers, e-mail addresses, street addresses, contact lists, instant messaging buddy lists, and other information relevant to a user. E-mail storage system 12 includes data storage devices that store the content of e-mail messages. E-mail web server 16 provides the Hypertext Markup Language (HTML) code for providing pages on browser 32 that display and interact with the e-mail system. Thus, e-mail web server 16 serves as the front end of the system that interacts with the browser, while e-mail server 10 provides the core business logic of the e-mail system. More information about a web based system can be found in United State Patent Application titled “Web Application Architecture,” inventors Aditya Bansod, Walter C. Hsueh and Chun Yu Wong, filed Jan. 4, 2005, Attorney Docket No. MSFT-01004US0, incorporated herein by reference in its entirety.

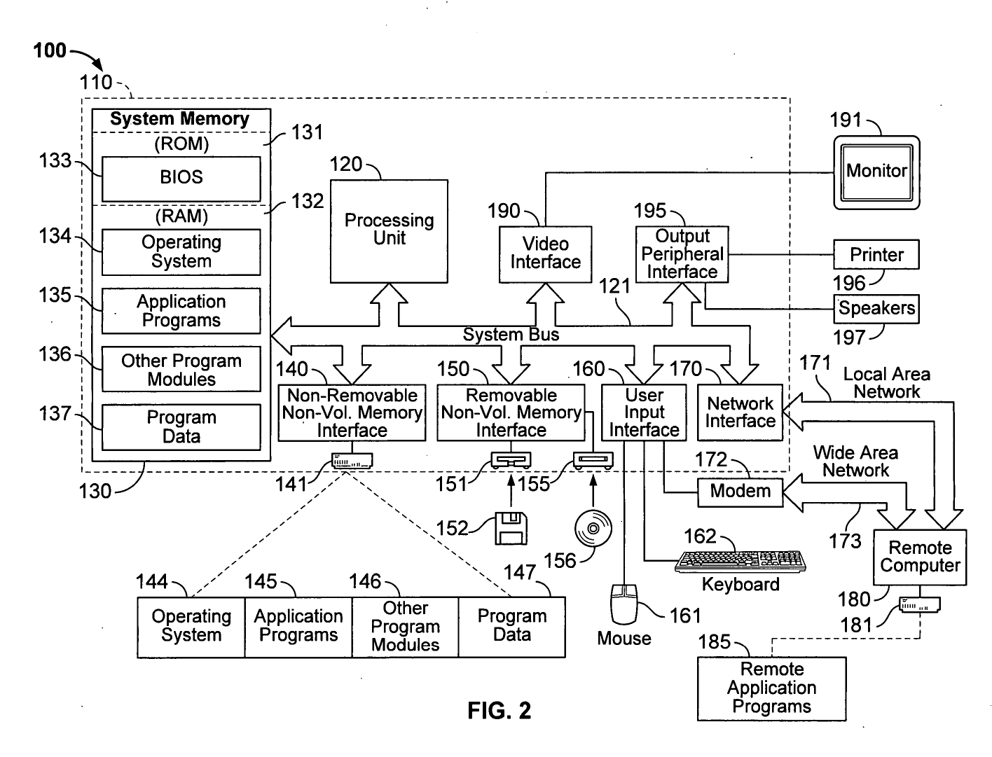

FIG. 2 illustrates an example of a suitable general computing environment that may be used as client computing device 30, email web server 10, email storage 12, ABCH 14 or email web server 16. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, personal digital assistants, telephones (wired, wireless, or cellular), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system for implementing the invention includes a general purpose computing device in the form of a computer 110. Components of computer 110 may include, but are not limited to, a processing unit 120 (which can include multiple processors), a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172, network interface or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

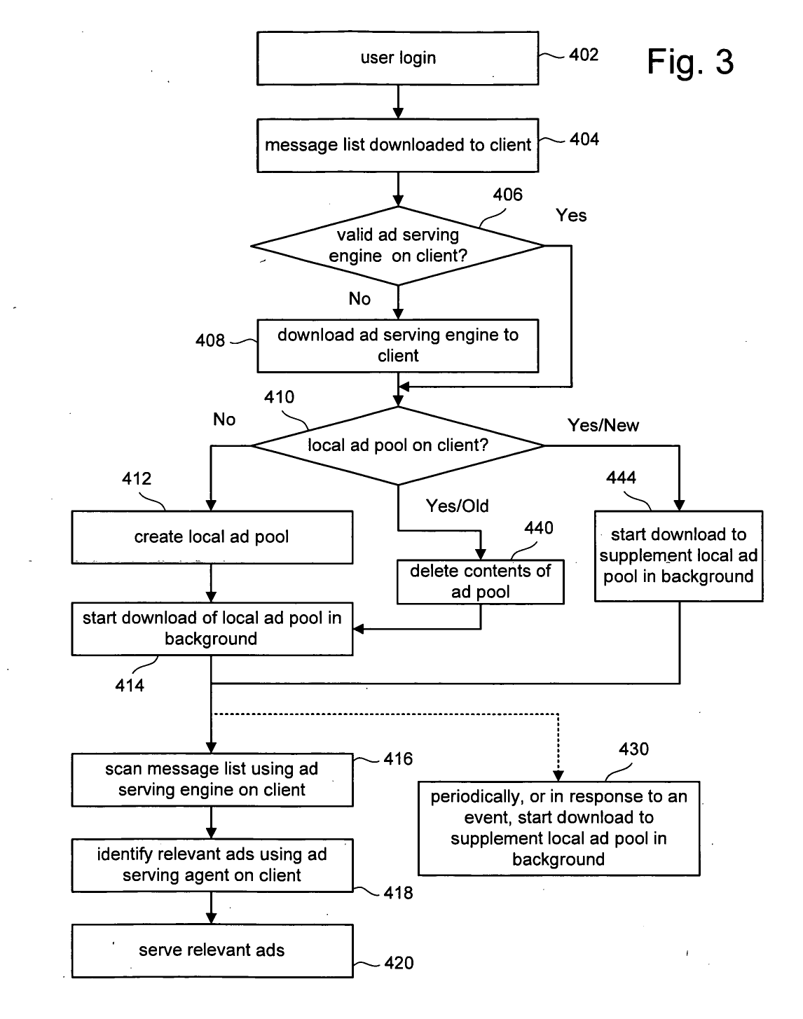

FIG. 3 is a flowchart describing one embodiment of a process that is performed when a user of client computing device 30 logs into a web-based e-mail service. In step 402, the user logs into the web-based e-mail service. For example, the user will open browser application 32 on client computing device 30 and navigate to the web page for the e-mail service. One example of an e-mail service is Hotmail. With Hotmail, the user would navigate to www.hotmail.com. Upon accessing the web page for the e-mail service, the user will be prompted to enter a user name and password. After entering that data, the e-mail service will authenticate the user. In some embodiments, the log-in process can be performed automatically or omitted. Additionally, other variations of the log-in process can be used.

After logging on, in step 404, the message list of the user's inbox is downloaded to client device 30. This is performed by e-mail server 10 accessing the messages from e-mail storage system 12 that are in the inbox for the user who logged in. In one embodiment, the information accessed by e-mail server 10 includes the “from” field, “subject” field, “date” field, “size” field, and indication whether there is an attachment. This information is then provided to e-mail web server 16, which creates an inbox page using HTML or another means. The inbox page is then transmitted from e-mail web server 16 to browser 32. In step 406, it is determined whether there is a valid ad serving engine 34 on client computing device 30. In one embodiment, the ad serving engine will have a time stamp. The time stamp can be the date it was saved on computing device 30 or another time stamp. If the ad serving engine is older than a certain predetermined period after the time stamp, then the ad serving engine is not valid. In one embodiment, an ad serving engine would be valid for a week. If there is no ad serving engine on client 30 or the ad serving engine is not valid, then a new ad serving engine is downloaded to client 30 in step 408.

After step 408, the system determines whether there is a local ad pool on the client (in step 410). Note that, if there was a valid ad serving engine on the client in step 406, and step 408 is skipped, then the process proceeds directly to step 410. If the pool of ads does not exist on client 30, then in step 412 a new local ad pool is created. In one embodiment, step 412 includes creating a file to store the ads. In one embodiment, the ads are stored in a document object. In step 414, the system starts downloading ads for storage in the local ad pool created in step 412. In one embodiment, the downloading is performed in the background using XMLHTTP. The ads are downloaded to client computing device 30 from e-mail web server 16, which receives the advertisements from e-mail server 10. In one embodiment, the ads were stored on e-mail storage system 12 prior to being downloaded. However, in other embodiments, the ads can be stored on an ad server 40 or other storage device. In another embodiment, the ads do not necessarily need to be downloaded from an e-mail server or dedicated ad server. Various websites can be configured so that, when a user visits those websites, advertisements are downloaded from those sites or from other locations. The pool of ads downloaded can be based on demographics from a user's accounts stored with the e-mail service, user interactions with the service or any other demographic data (or other data) available to the service. In some embodiments, ads are downloaded randomly. In yet another embodiment, an ad repository can be set up with an application program interface (API) so that ad serving engine 34 can access and download ads via the API. The downloading of the advertisement should not take a large amount of bandwidth because, in one embodiment, the ads are text ads. The downloading of the ads will occur in the background and not interrupt or block the user interface. This can be accomplished in a web browser using XMLHTTP. The number of ads downloaded is configurable.

In step 416, ad serving engine 34 scans the message list downloaded in step 404. This scanning is performed on client computing device 30. Note that because the ads downloaded in step 414 are downloaded in the background, step 416 can commence prior to the completion of step 414. In step 418, ad serving engine 34 identifies ads from the local ad pool that are relevant to the message list. In one embodiment, scanning the message list can include scanning the “subject” line, the “from” field, the “date” field or a combination of the above. In some embodiments, only one field is scanned. In other embodiments, all the fields are scanned. In step 420, the ads determined to be relevant to the message list are served. That is, step 420 includes displaying the ads in browser 32 with the display of the message list. Thus, the user will see the user's inbox and the relevant ads. Step 420 can be performed by ad serving engine 34 or another process (including the browser or processes associated with the browser).

If in step 410 it is determined that a local ad pool does exist on the client but the local ad pool is old, then the contents of the local ad pool will be deleted in step 440. After step 440, the process will continue at step 415, at which time the system will start downloading new ads to store in the local ad pool. In one embodiment, the local ad pool is provided with a time stamp. If more than a predetermined amount of time has passed since the time stamp, then the ad pool will determine to be old. For example, if the ad pool is more than a week old, it will be discarded. In other embodiments, each ad will have its own time stamp and individual ads will be discarded on an individual basis.

If in step 410 it is determined that the local ad pool does exist and is not old, then in step 444 a download process will begin to provide additional ads to the local ad pool. This download process will be performed in the background. Note that after step 414, FIG. 3 shows a dash line to step 430. Step 430 includes periodically, or in response to an event, starting to download additional ads to the ad pool. Step 430 is performed in the background after completion of step 414. Step 430 can be performed in parallel to step 416-420 or after step 416-420. In one embodiment, step 430 is performed on a periodic basis. In other embodiments, step 430 can be performed in response to various events such as a user accessing an inbox, performing a particular action with respect to the e-mail service, etc. In one embodiment, ads are continuously downloaded. Further note that, in one embodiment, if the user (already logged in) is not accessing the inbox but attempts to then access the user's inbox, a process similar to FIG. 3 (starting at step 404) can be performed.

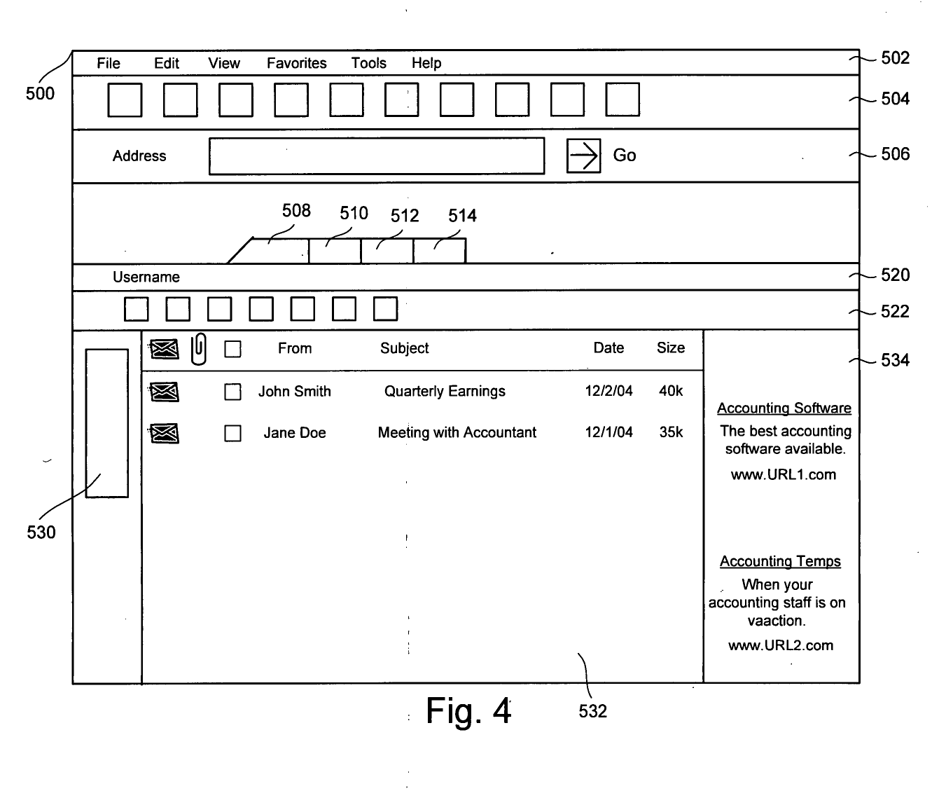

FIG. 4 provides an example of a GUI 500 that would be provided on a monitor or other display device for client computing device 30 at the completion of the process of FIG. 3. Drop-down menus 502 includes a File drop-down menu, Edit drop-down menu, View drop-down menu, Favorites drop-down menu, Tools drop-down menu and Help drop-down menu. Below the drop-down menus 502 are buttons 504, which include buttons for going back, going forward, stopping, reloading, going to a home page, searching, accessing favorites, etc. Below buttons 504 is address field 506 with a Go button. The GUI also includes several tabs 508, 510, 512 and 514 for navigating between a mail service, calendar service, address book and other services. Below the tabs is a field to indicate the user name 520 of the user logged into the e-mail service. Below the user name are a series of buttons 522 to allow the user to create a new e-mail, delete an e-mail, block an e-mail, move an e-mail to a different folder, search or mark an e-mail as being read/unread/important. GUI also includes a set of links 530 for navigating the user to various portions of the e-mail service, including inbox, junk e-mail, sent messages, draft messages and a trash can. GUI 500 will include inbox 532, which lists the various messages. In one embodiment, the list of messages in inbox 532 corresponds to the message list downloaded in step 404 of FIG. 3. In the embodiment of FIG. 4, the inbox includes the “from” field, “subject” field, “date” field, size of the e-mail, indication of whether there is an attachment (paperclip) and indication of whether the mail has been read (open envelope) or unread (closed envelope). In other embodiments, other data can be provided in the inbox.

GUI 500 also includes ads 534. In FIG. 4, two ads are depicted. However, in other embodiments, less than or more than two ads can be depicted. The two example ads include an ad for an accounting software and an ad for temporary accounting workers. Obviously, other ads can also be used. The ads include three fields: a title, text description and a URL. For example, in the first ad, the title is “Accounting Software,” the text is “The best accounting software available,” and the URL is “www.URL1.com.” In the second ad, the title is “Accounting Temps,” the text is “When your accounting staff is on vacation,” and the URL is “www.URL2.com.” In some embodiments, the title can serve as a link that will take the user to the website at the target URL. In other embodiments, the URL and/or the text may also serve as a link. Thus, if the user clicks on “Accounting Software” or another associated link, the user will be navigated to the website at www.URL1.com. Other variations of GUI 500 and other formats for ads can also be used with respect to the present invention. For example, if the invention is being used with a mobile telephone, the display on a mobile telephone would be smaller than a computer and, thus, not all of the elements of GUI 500 will be included. Other embodiments include providing the ads in a means other than displaying it, such as providing the ads using audio data. For example, the ads can be read using text-to-speech technology known in the art. Alternatively, the ads can be in an audio format such as WAV, MP3, or any other suitable audio format. Similarly, the e-mail messages can be provided in an audio format as well.

When viewing GUI 500, the user can select any of the messages listed in the inbox. In one embodiment, by double-clicking on a message in the inbox, the user will have the entire (or a portion of) message displayed to the user. In some embodiments, a pop-up window will be created and the message will be displayed in the new pop-up window. In other embodiments, the window displaying GUI 500 will remove GUI 500 and replace it with the selected message.

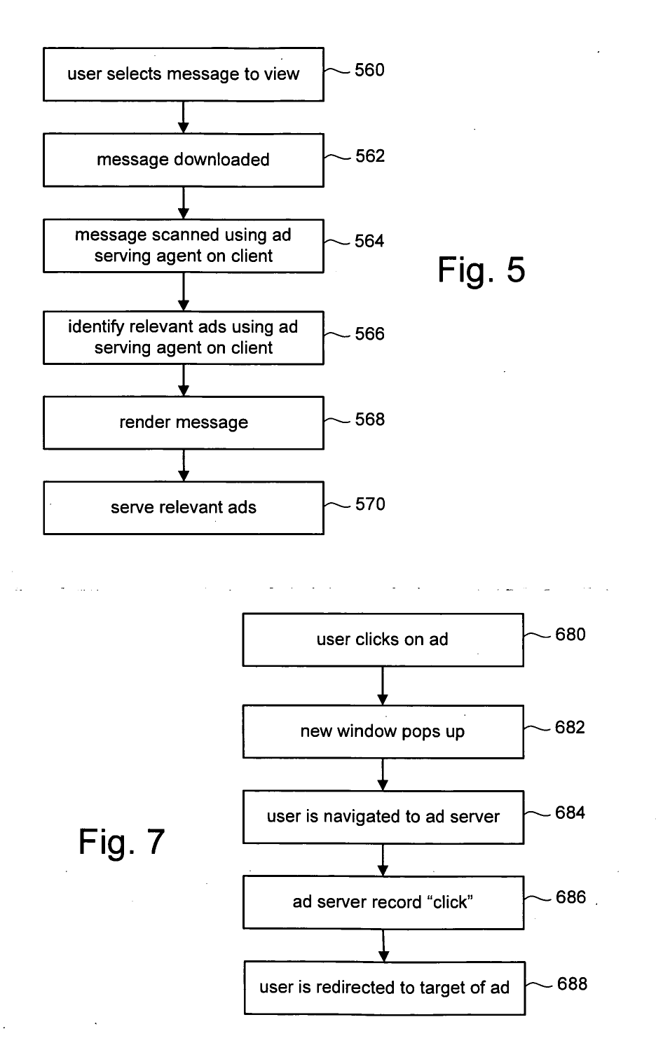

FIG. 5 is a flowchart describing one embodiment performed when a user selects one of the messages from an inbox. In step 560, the user selects the message to view by single-clicking with a pointing device, double-clicking with a pointing device, or using another means known in the art. In step 562, the data for the message is downloaded. In one embodiment, browser 32 will make a request to e-mail web server 16 for the e-mail message. That request will be forwarded to e-mail server 10, which will get the data from e-mail storage system 12 and provide that data back to e-mail web server 16. E-mail web server 16 will then create the code for implementing the page displaying the message and communicate that data, via Internet 18, to browser 32. In step 564, ad serving engine 34 will scan the data of the message received. This scanning of the message can include scanning the entire set of data for the message, only the body portion, only the summary portion, only any one of the fields of the message, or any combination of fields of the message. In step 566, ad serving engine 34 will identify ads from the ad pool that are relevant to the message. In step 568, the message is rendered in browser 32. In step 570, the ads identified as being relevant in step 566 are served to the user by rendering them in the browser (or another mode of serving the ad) in step 570. In one embodiment, ad serving engine 34 renders the ads. In other embodiments, other components can render or otherwise serve the ads.

Ad serving engine runs on client computing device 30. Therefore, while the server knows that ads were downloaded to the user's machine, the server does not know which ads were specifically displayed to the user. In one embodiment, ads are provided when a user sees a particular message. In another embodiment, ads are provided only when the inbox is displayed. In other embodiments, ads are displayed at both instances. In another embodiment, ads can be displayed at other times.

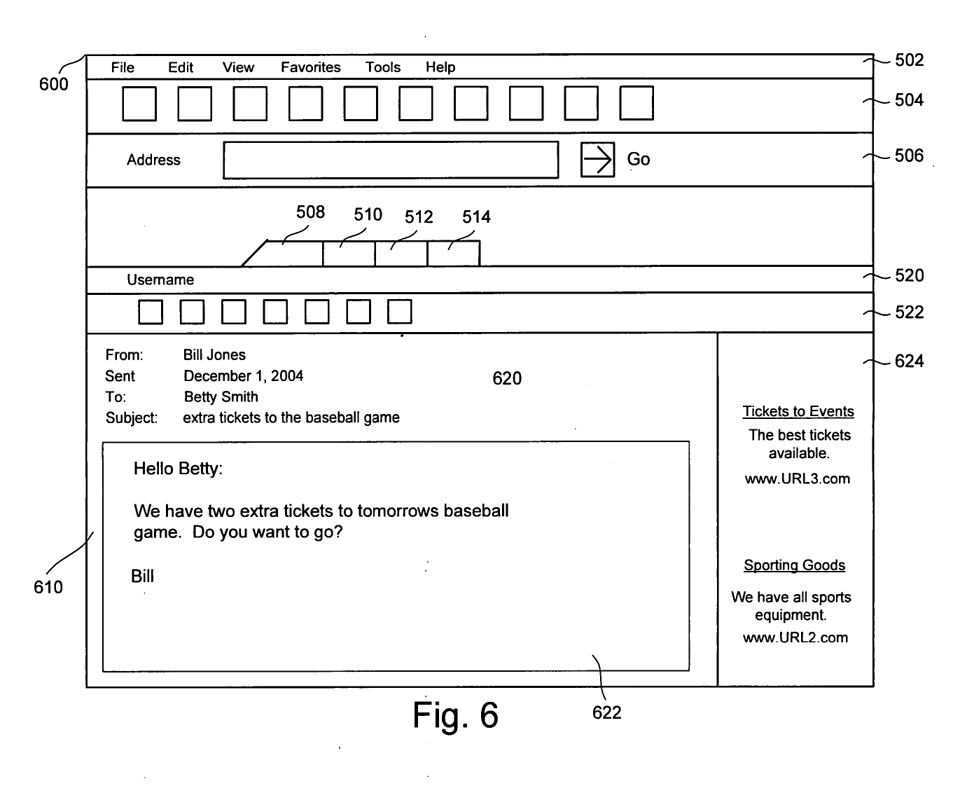

FIG. 6 provides an example of GUI 600, which is displayed as a result of the process of FIG. 5. Rather than depicting an inbox, GUI 600 depicts an e-mail message 610, which includes header information 620 and body 622. Header information 620 includes indication of who the e-mail is from, the date the e-mail was sent, the intended recipients of the e-mail and a subject field. The body of the message 622 includes the text of the message. GUI 600 includes ads 624. In the embodiment of FIG. 6, two ads are shown; however, more or less than two ads can be depicted. Similar to FIG. 4, the ads include title, text and a URL, although other data can be included.

When a user clicks on an ad, that user is taken to a destination associated with the ad. FIG. 7 is a flowchart describing one embodiment of the process performed when a user clicks on an ad. In step 680, the user clicks on the ad using a pointing device or other instrumentality. In step 682, a new window pops up. In embodiments that do not include windows, step 682 can be skipped. In step 684, the user is navigated to ad server 40 (or another server). In step 686, ad server 40 receives the request from the browser. That is, by clicking on the ad, the browser sends an HTTP request using the associated URL to ad server 40. The ad server will receive the HTTP request and record that an entity has clicked on the particular ad. Each HTTP request will indicate which ad it is associated with. For example, the URL associated with the link for the ad will point to the ad server and will include data within the URL to indicate which ad is associated with the URL. For example, in one embodiment, the target of the ad can be embedded within the URL. For example, the following URL can be used:
http://email.webemailserviceexample.com/pagead/adclick?sa=1&adur1=http ://www.URL 1.com/solutions/

In the above example, the ad server is at “email. webemailserviceexample.com.” When the ad server receives the request, the ad server parses the URL to see the target of the ad (www.URL1.com/solutions/) and records a click for that ad. Many ads are paid for by the advertiser according to the number of times users click on the ads. Additionally, ad server 40 will remove the target URL (e.g., “http://www.URL1.com/solutions/”) and use that URL to redirect the user to the target in step 688.

In another embodiment, rather than embedding a target URL in the URL of ad server 40, the ad server can have a large number of URLs that are all resolved to ad server 40. However, each URL corresponds to a record in a table. Each record in a table corresponds to a different target location to redirect the user to. Thus, based on the received URL, the ad server will record a click for the appropriate ad and redirect the user to the appropriate destination. Other suitable schemes can also be used.

As discussed above, ad serving engine scans the e-mails and determines which ads are relevant to the e-mails. There are many different means for determining which ads are relevant to an e-mail. The present invention can be used with any number of such schemes known in the art. Examples of technology can be found in U.S. Pat. No. 6,330,554; U.S. Pat. No. 6,665,653 and U.S. Pat. No. 5,704,017, all of which are incorporated by reference in their entirety. In one embodiment, providers of the advertisements or providers of the e-mail service will create a set of key words for each ad. When ad server engine 34 scans the relevant portions of the e-mail, ad-server engine 34 will store the words of the e-mail. If the words of the e-mail match the key words for the advertisement, then the advertisement is considered to be relevant. In some embodiments, the relevance can be weighted based on how many words match. Alternatively, certain key words can be weighted higher than other key words.

In addition, the ad can be chosen by monitoring the user's actions when interacting with client computing device 30 and predicting, based on the user actions, which advertisements would be relevant to the user. In another embodiment, the advertisements can be selected by looking at data stored on the user's computer. Based on that data, the relevant ads can be chosen.

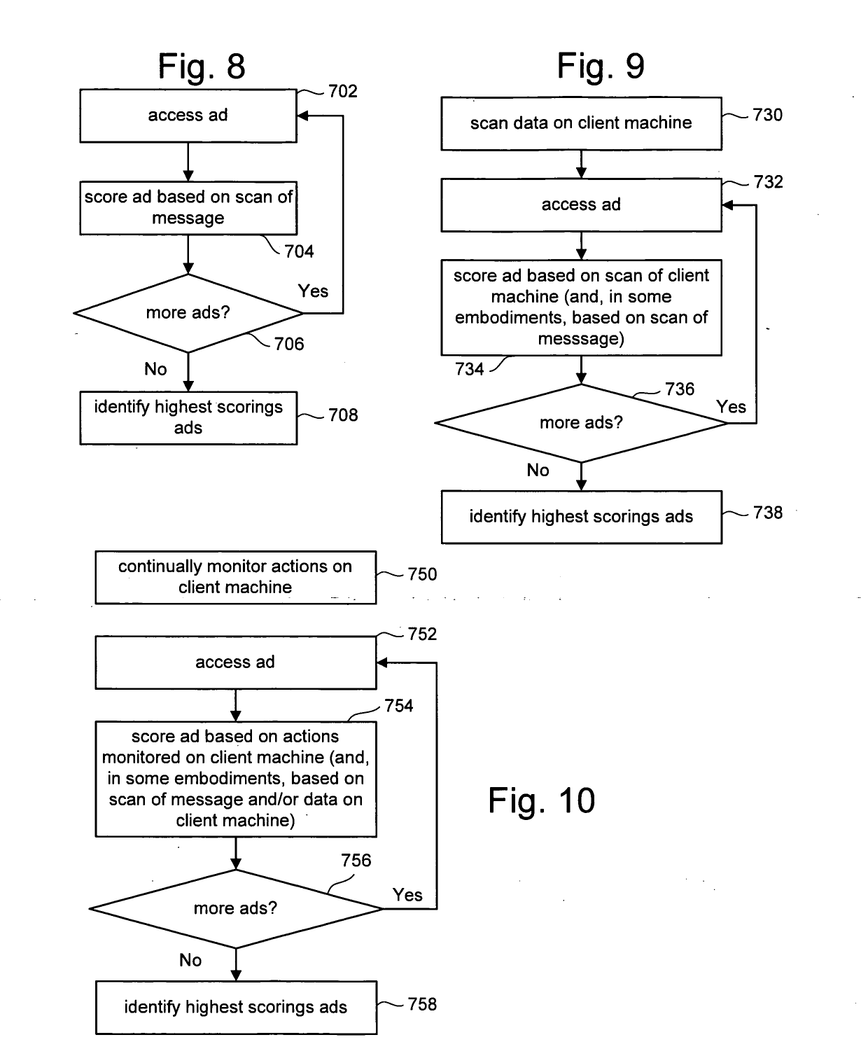

FIG. 8 is a flowchart describing one embodiment or choosing a set of relevant ads (e.g., steps 418, 566). In step 702, one of the ads in the local ad pool is accessed. In step 704, that ad is scored based on the scan of the message. That is, ad serving engine 34 matches words in the e-mail message with the key words of the advertisement. Alternatively, the scoring can include the weighting described above. Alternatively, other schemes for scoring the relevance of the message to the ad can be performed. In step 706, it is determined whether there are more ads to access. If so, the process loops back to 702 and the next ad is accessed. If all the ads have been considered, then in step 708, the highest scoring ads are identified. In some embodiments, only two or three ads will be displayed at a time. Therefore, the highest scoring two or three ads will be identified in step 708. In some embodiments, there will be a threshold score and only those ads above the threshold will be identified. In other embodiments, there will be a predefined number and that predefined number of high-scoring ads will be identified. Note that there are many methods for scoring relevance of ads that are known in the art, many of which are used today with respect to search engines. Many of these known schemes can be used.

FIG. 9 is flowchart describing another embodiment of a process for determining which ads are relevant. The process of FIG. 9 bases the relevance determination on data stored on the user's machine. In step 730, the system will scan data on the client machine. For example, various directories can be scanned to determine the content of the directories. This may include reading all the titles of files stored in a directory. In another embodiment, system can access the content of the files stored on the computer. For example, if there are a number of word processing documents, the text of the word processing documents can be looked at. The system can also access text within other file formats other than word processing documents. For example, the system can look at titles, artist, album and/or genre of music files. In one embodiment, the system can access the ID3 tag of an MP3 file or other header information of other music or video files. In step 732, one of the ads in the local pool is accessed. In step 734, that ad is scored as to relevancy with the data scanned on the client machine in step 730. In some embodiments, in addition to scoring the ad based on the data scanned in step 730, the ad can be scored also based on relevancy to the text of the e-mail. That is, one embodiment includes scoring the ad based on relevancy to both data on the computer and text in the e-mail. Any one of the various scoring technologies known in the art can be used for step 734. In step 736, it is determined whether there are anymore ads to access. If yes, the process loops back to step 732 and the next ad is accessed. If all the ads have been considered, then in step 738, the highest-scoring ads are identified, as discussed above with respect to step 708.

In one embodiment, step 730 can include scanning all (or a subset of) the music files on a user's computing device. When the advertisements are downloaded, the system may download advertisements for various songs, compact discs, albums, concerts or other music related items. In step 734, ad serving engine 34 will try to match the music files to the ads. In one embodiment, ad serving engine 34 will identify ads regarding albums/compact discs or songs for artists for which the user has other music files of the same artist. Or, ad serving engine 34 will identify ads regarding albums/compact discs or songs predetermined to most likely be interesting to persons who already have music/videos by artists for which the user has other music/video files of the same artist. In another embodiment, the ad serving engine 34 will attempt to identify ads for videos by the same actors, directors, genre, etc. of video files stored on client 30. In another alternative, the scanning of data on the computer in step 730 could include scanning other applications such as calendar applications, contact applications, as well as the time/date/day of week/time zone/wallpaper of client computing device 30.

FIG. 10 is a flowchart describing one embodiment of a process for identifying relevant ads based on actions monitored on client machine 30. For example, ad serving engine 34 may monitor all the websites that a user navigates to, applications opened by a user, etc. In step 750, ad serving engine 34 will continually monitor actions on a client machine. Step 700 may proceed for long periods of time. In step 752, the first ad of the local ad pool is accessed. Note that in FIG. 10, there is no line connecting step 750 to 752 because in one embodiment step 750 is continually performed. Step 752 can be performed when it is time for ad serving agent 34 to identify relevant ads. Thus, step 750 can be performed at the same time that step 752 is performed, or at different times. In step 754, the accessed ad is scored as to relevance based on the actions monitored in step 750. In some embodiments, the ad can also be scored based on a combination of the actions monitored and the content of e-mail. The system for scoring can be based on any of various technologies known in the art, including those discussed above. In step 756, it is determined whether there are any more ads to consider. If there are more ads in the ad pool to consider, then the process loops back to step 752. If all the ads have been considered, then in step 758, the highest scoring ads are identified, as discussed above with respect to step 708. Note that in one embodiment, the processes of FIGS. 8, 9 and/or 10 can be performed by ad serving engine 34 exclusively operating on client computing device 30.

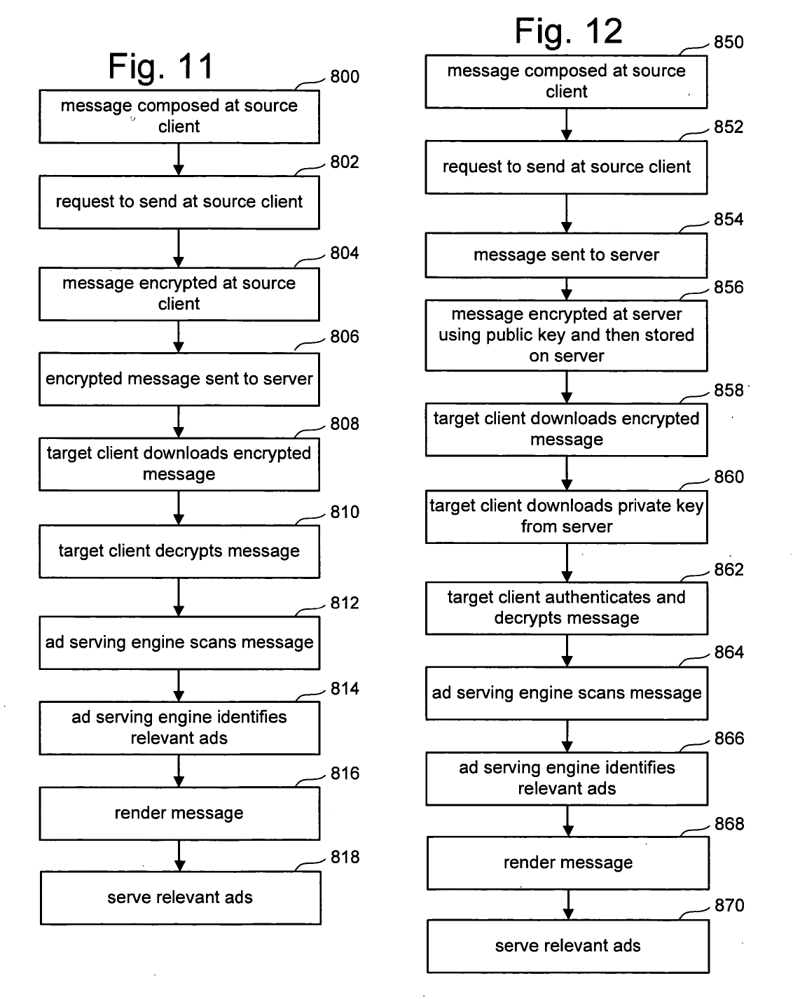

In one embodiment, to further the user's privacy, e-mail can be stored in e-mail storage system 12 in an encrypted form. FIG. 11 is a flowchart describing one embodiment for sending e-mail that is stored in an encrypted form. In the environment of FIG. 11, the sender and receiver of the e-mail will have previously exchanged public keys. The user's private keys will be stored on the respective user's client devices. In one alternative, the user can store the user's private key in a password protected repository accessible via the Internet. This way, the user can access the key from any client device.

In step 800 of FIG. 11, the sending user will compose the message at the source client. In step 802, a request to send the message will be sent from the source client to e-mail server 10. In step 804, the message will be encrypted at the source client. For example, ad serving engine 34 can encrypt the message using the recipient user's public key. In another alternative, another software process can encrypt the message. In step 806, the encrypted message is sent to e-mail server 10 (via e-mail web server 16). E-mail server 10 will store the encrypted e-mail in email storage 12. In step 808, the target client will download the encrypted message. For example, the user associated with the target client machine will log into the e-mail service and receive a GUI of the user's inbox. The user will double-click on the message. In response to double-clicking on the message, the browser for the target client will request the message from e-mail server 10. That message will be downloaded in step 808. In step 810, the target client will decrypt the message using the recipient user's private key. In step 812, ad serving engine 34 will scan the message, as described above. In step 814, the ad serving engine will identify the relevant ads. In step 816, the message will be rendered in the browser for the receiving user. In step 818, the relevant ads will be served (e.g., rendered) in the browser for the receiving user.

FIG. 12 provides an alternative embodiment for sending encrypted e-mail where the e-mail is encrypted at the server, but decrypted at the target user's client device. In step 850, the message is composed at the source client device. In step 852, the browser at the source client device requests to send the e-mail to e-mail server 10. In step 854, the message is sent to e-mail server 10. In step 856, e-mail server 10 will encrypt the e-mail. It is anticipated that the target recipient user will have provided a public key to e-mail server 10. The encrypted e-mail will then be stored on e-mail storage system 12. In step 858, the target client will download the encrypted message. As discussed above, the download will be in response to the user requesting to view the message, as described above. In step 860, target client will download the private key from the server. In one embodiment, the recipient's private key will already be at the client device. In another embodiment, the recipient will have the opportunity to download the private key from the server by using a password to access the private key. Only users who authenticate properly can download the key. In one alternative, use of the key will also require authentication to prevent the key from being used by another individual. In step 862, the target client will authenticate the user and decrypt the message if the user properly authenticates. In step 864, ad serving engine 34 will scan the message, as described above. In step 866, the ad serving engine identifies the relevant ads, as described above. In step 868, the message is rendered in the browser. In step 870, the relevant ad is served (e.g., rendered) in the browser.

The above-discussed embodiments contemplate that one or more advertisements are selected based on content in the user's e-mail, content on the user's computer, and/or user's actions. The relevant ads are then displayed with all or portions of one or more e-mails. In other embodiments, the relevant ads that are identified based on e-mail content, data on user's computer and/or actions by the user can be served to the user separately from the e-mail (e.g. with another application). For example, based on e-mails, user data and/or user actions, advertisements may appear on a user's desktop, in a window for other applications, in any GUI on the computer, via a speaker, etc. The technology described herein is not limited to displaying ads within an e-mail system.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A method for providing advertisements, comprising:
accessing content of a first message at a first client device, said content is received from a server;
identifying one or more advertisements from a larger set of advertisements that are relevant to said content of said first message, said identifying is performed on said first client device; and
providing said one or more advertisements at an output of said first client device.

2. A method according to claim 1, further comprising:
decrypting said first message at said first client device prior to said accessing content.

3. A method according to claim 2, further comprising:
creating said first message at a second client device;
encrypting said first message at said second client device;
sending said first message to said server after encrypting said first message; and
receiving said first message at said first client device.

4. A method according to claim 2, further comprising:
creating said first message at a second client;
sending said first message to said server;
encrypting said first message at said server;
storing said encrypted first message at said server; and
sending said first message to said first client device.

5. A method according to claim 1, further comprising:
creating said first message at a second client;
sending said first message to said server;
storing said first message in an encrypted form at said server; and
sending said first message to said first client device.

6. A method according to claim 1, wherein:
said identifying one or more advertisements includes determining which subset of advertisements are relevant to said content and to other data on said first client device.

7. A method according to claim 1, wherein:
said identifying one or more advertisements includes determining which subset of advertisements are relevant to said content and to actions performed by a user on said first client device.

8. A method according to claim 1, wherein:
said first message is a web based email message.

9. A method according to claim 1, wherein:
said one or more advertisements are text based.

10. A method according to claim 1, further comprising:
downloading advertisements at various times and storing said downloaded advertisements; and
deleting said stored advertisements after a predetermined amount of time.

11. A method according to claim 1, wherein:
said accessing content includes scanning all portions of said first message.

12. A method according to claim 1, wherein:
said accessing content includes scanning a body of said first message.

13. A method for providing advertisements, comprising:
accessing content on a first client device;
choosing an advertisement based on user data for said first client device, said choosing is performed on said first client device; and
providing said advertisement at an output of said first client device.

14. A method according to claim 13, wherein:
said content is an email message; and
said providing said advertisement includes displaying said advertisement with a display of at least a portion of said email message.

15. A method according to claim 13, wherein said choosing said advertisement based on user data comprises:
determining which one or more advertisements of a set of advertisements are most relevant to said data in files stored on said first client device.

16. A method according to claim 13, wherein said choosing said advertisement based on user data comprises:
determining which one or more advertisements of a set of advertisements are most relevant to actions taken on said first client device.

17. A method according to claim 13, wherein:
said advertisement is for music;
said accessing content includes said scanning said first client device for music files; and
said choosing said advertisement based on user data comprises determining which music advertisement is relevant to one or music files found on said first client device.

18. One or more processor readable storage devices having processor readable code embodied on said processor readable storage devices, said processor readable code for programming one or more processors to perform a method comprising:
accessing content of a first email message on a client device;
identifying one or more advertisements from a larger set of advertisements that are most relevant to said content of said first email message, said identifying is performed on said client device; and
displaying said one or more advertisements with said first content.

19. One or more processor readable storage devices according to claim 18, wherein said method further comprises:
decrypting said first message at said first client device prior to said accessing content.

20. One or more processor readable storage devices according to claim 19, wherein:
said identifying one or more advertisements includes determining which subset of advertisements are most relevant to said content and to other data on said first client device.
